(19) United States
(12) Patent Application Publication
(10) Pub. No.: US 2007/0052590 A1
(43) Pub. Date: Mar. 8, 2007

(54) Miniatured microstrip antenna

(76) Inventors: Tze-Hsuan Chang, Taipei City (TW); Jean-Fu Kiang, Taipei City (TW)

Correspondence Address: LIN & ASSOCIATES INTELLECTUAL PROPERTY, P.O. BOX 2339, SARATOGA, CA, 95070-0339, US

(21) Appl. No.: 11/209,922

(22) Filed: Aug. 23, 2005

(51) Int. Cl. H01Q 1/38

(52) U.S. Cl. 343/700 MS

(57) ABSTRACT

This invention is a miniaturized microstrip antenna, which consists of one antenna element and one feeding structure. The antenna element is the first metal pattern printed on the first dielectric layer to radiate or receive electromagnetic wave at a specific frequency band. The feeding structure is used to deliver signals to or from the antenna element. The first metal pattern consists of two sets of parallel wires, with one set perpendicular to the other. The geometrical parameters of the first metal pattern determine the specific frequency band of electromagnetic wave to be radiated or received.

### BACKGROUND OF THE INVENTION

1. Field of the Invention

The invention is related to a miniaturized microstrip antenna, more particularly to provide the microstrip antenna with a significantly lower resonant frequency.

2. The Prior Arts

The prior art of the microstrip antenna is formed by paving metal lines on a dielectric board to receive or transmit signal at a specific frequency band, and usually fabricated by the simple arrangements of strip-shaped transmission lines; the prior art also applies the transmission line theory to implement the design of the microstrip antenna. The operation frequency of a traditional microstrip antenna is determined by the size of the antenna; although increasing the dielectric coefficient of the dielectric board can reduce the area of the antenna significantly, it also greatly reduces the gain and bandwidth of the antenna; moreover, the cost for a high-dielectric coefficient material is usually higher than others too. In addition, carving grooves on the microstrip antenna can change the current flow path, which lengthens the current path when resonance, and thus reduces the area of antenna. Also, inserting a metal plate or a metal pin into an end of antenna, or cutting a microstrip antenna into two halves and then connect them with an inductance element, can both reduce the area of antenna, but all of these fabrication methods will increase the manufacturing complexity and cost for the microstrip antenna. Therefore, this invention is developed to solve the problems of the traditional microstrip antenna mentioned above.

### SUMMARY OF THE INVENTION

This invention is related to a kind of miniaturized microstrip antenna, which actually removes one or more above-mentioned limitations or drawbacks of the related arts.

The main object of the miniaturized microstrip antenna of this invention is to provide a microstrip antenna which has longer electric length for current so as to shrink the size of microstrip antenna.

Another object of the miniaturized microstrip antenna of this invention is to try metallic patterns with various geometric grids or zigzags to obtain the optimum parameters on the microstrip antenna design.

One more object of the miniaturized microstrip antenna of this invention is to provide a feeding element to work with the microstrip antenna to output and input the antenna signal efficiently.

One more object of the miniaturized microstrip antenna of this invention is to provide an easy fabrication and a low-cost manufacturing for the microstrip antenna by using the simple geometric shapes on the microstrip antenna.

To achieve the aforementioned objects, the invention is related to a miniaturized microstrip antenna, which comprises: an antenna element made by paving a first wire pattern on the surface of a first dielectric layer, wherein the first wire pattern is a metal circuit for receiving and transmitting specific signals; and a feeding element to work with the antenna element for feeding specific signals to the antenna element to transmit, or capturing signals received by the antenna element; wherein the first wire pattern is the layout circuit which consists of a plurality of horizontal wires and vertical wires, and the geometric size defined by the first metal pattern determines the specific frequency band to be received or transmitted.

The objects and the functions of this invention can be further explained by referring the drawings below.

### BRIEF DESCRIPTION OF THE DRAWINGS

FIG. 1 is the perspective view showing a preferred embodiment of the antenna element combining with the feeding element in the miniaturized microstrip antenna of the invention.

FIG. 2 shows the wire pattern of the first preferred embodiment of the antenna element in the miniaturized microstrip antenna of the invention.

FIG. 3 shows the wire pattern of a preferred embodiment of the feeding element in the miniaturized microstrip antenna of the invention.

FIG. 4 shows the wire pattern of the second preferred embodiment of the antenna element in the miniaturized microstrip antenna of the invention.

FIG. 5 shows the wire pattern of the third preferred embodiment of the antenna element in the miniaturized microstrip antenna of the invention.

FIG. 6 shows the wire pattern of the fourth preferred embodiment of the antenna element in the miniaturized microstrip antenna of the invention.

FIG. 7 shows the wire pattern of the fifth preferred embodiment of the antenna element in the miniaturized microstrip antenna of the invention.

FIG. 8 shows the wire pattern of the sixth preferred embodiment of the antenna element in the miniaturized microstrip antenna of the invention.

### DETAILED DESCRIPTION OF THE PREFERRED EMBODIMENT

Please refer the attached drawings for further explanation on the preferred embodiments of the invention in the following. Some scales are exaggerated compared to others to provide clearer descriptions, which will thus help the reader to understand the invention.

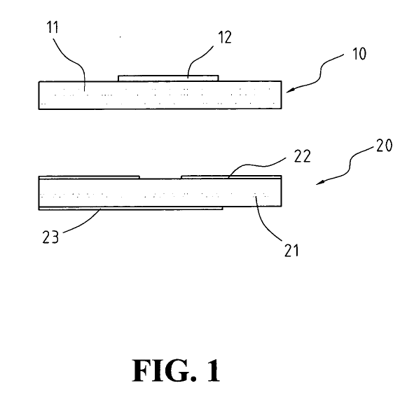

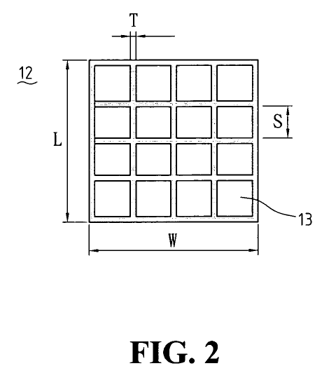

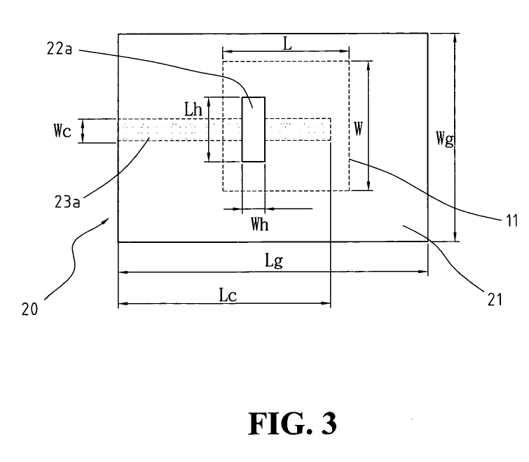

FIG. 1 shows perspective view of a preferred embodiment of the antenna element working with the feeding element in the miniaturized microstrip antenna of the invention. FIG. 2 shows the circuit pattern of a preferred embodiment of the antenna element in miniaturized microstrip antenna of the invention. FIG. 3 shows the feeding element of a preferred embodiment in the miniaturized microstrip antenna of the invention.

Referring FIG. 1, the miniaturized microstrip antenna of the invention can receive and transmit a specific band of signal through an antenna element (10), which is made by paving a first wire pattern (12) on the surface of a first dielectric layer (11). The first dielectric layer (11) is a board made of FR4, Teflon, Duriod, fiber glass, aluminum oxide, ceramics or other dielectric material; the first wire pattern (12) is the wire circuit paved on the surface of the first dielectric layer (11). FIG. 2 shows a preferred embodiment of the wire pattern of an antenna element and the first wire pattern (12) is the grid wire that consists of a plurality of square grids (13); wherein the length and the width of the first wire pattern (12) are L and W respectively, and the width of each of the grids (13) is S and the width of the wire is T.

The above-mentioned antenna element (10) working together with the feeding element (20) can receive and transmit signals. The feeding element (20) made by paving a second wire pattern (22) on the top and paving a third wire pattern (23) on the bottom of a second dielectric layer (21). The second dielectric layer (21) is a board made of FR4, Teflon, Duriod, fiberglass, aluminum oxide, ceramics or other dielectric materials. The second wire pattern (22) and the third wire pattern (23) are the wire circuits paved on the top and on the bottom of the second dielectric layer (21), respectively. FIG. 3 shows the preferred embodiment of the wire pattern of the feeding circuit; the second wire pattern (22) forms a ground metal layer, which length and width are Lg and Wg, respectively. A portion of the second wire pattern (22) is removed as a hollow portion (22a), of which the length and width are Lh and Lw, respectively. The third wire pattern (23) forms a strip-shaped metal layer, which length and width of Lc and Wc, respectively. The area surrounded by the dotted lines on FIG. 3 is the projection of the microstrip meshed antenna which is the first wire pattern (12) on the antenna element (10).

Every geometrical parameter of the above-mentioned antenna element (10) with the feeding element (20) in the miniaturized microstrip antenna of the invention including L, W, S, T, Lg, Wg, Lh, Wh, Lc and Wc can be optimized by numerical analysis method or simulation program. Furthermore, the relative locations of the hollow portion (22a) with respect to the first wire pattern (12), the second wire pattern (22), and the third wire pattern (23) are also the parameters to be adjusted for the invention.

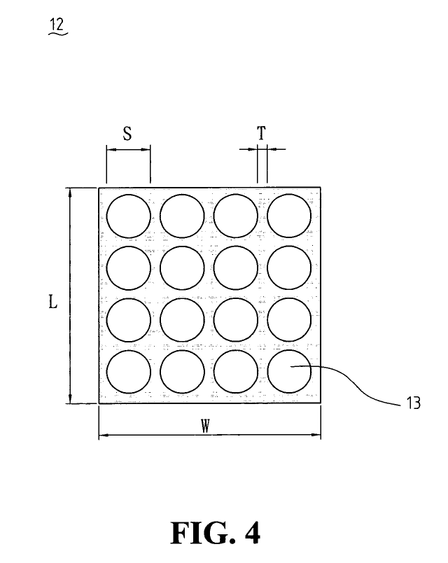

FIG. 4 shows the wire pattern of the second preferred embodiment of the antenna element in the miniaturized microstrip antenna of the invention. Referring FIG. 4, the first wire pattern (12) is the grid distribution circuit consisting of a plurality of round grids (13), and the diameter of each of the round grids is S.

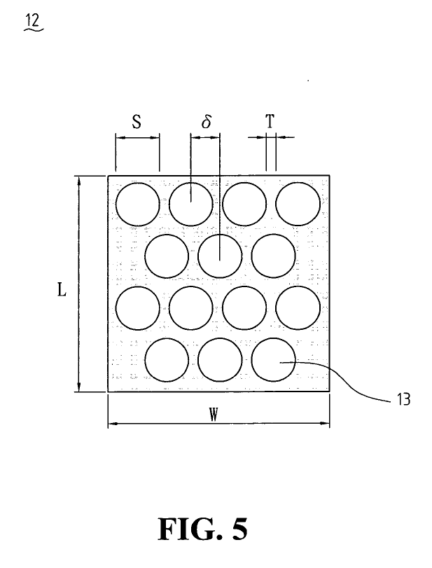

FIG. 5 shows the wire pattern of the third preferred embodiment of the antenna element in the miniaturized microstrip antenna of the invention. Referring FIG. 5, the first wire pattern (12) is the grid distribution circuit consisting of a plurality of round grids (13), on which the diameter of each of the round grids is S and the offset distance between adjacent rows of the round grids (13) is δ.

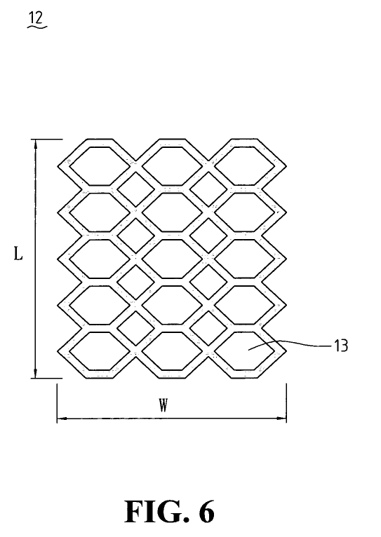

FIG. 6 shows the wire pattern of the fourth preferred embodiment of the antenna element in the miniaturized microstrip antenna of the invention. Referring FIG. 6, the first wire pattern (12) is the grid distribution circuit consisting of a plurality of hexagon grids (13), the diameter of each of the hexagon grids (13) is S.

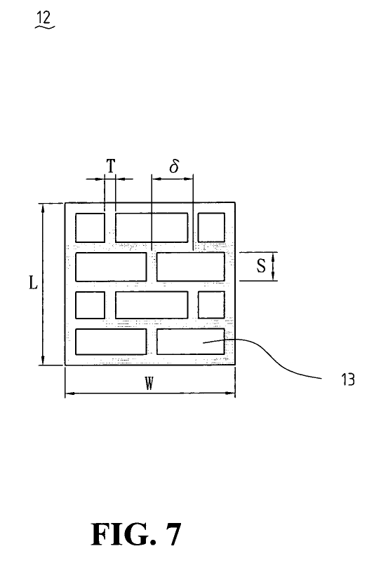

FIG. 7 shows the wire pattern of the fifth preferred embodiment of the antenna element in the miniaturized microstrip antenna of the invention. Referring FIG. 7, the first wire pattern (12) is the grid distribution circuit consisting of a plurality of rectangle grids (13), on which the width of each of the rectangle grids (13) is S and the offset distance between adjacent rows of the rectangle grids (13) is δ.

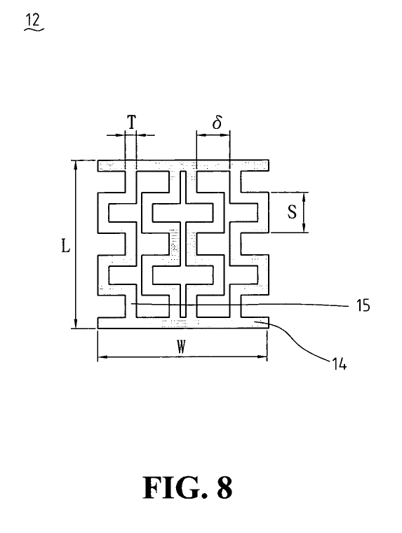

FIG. 8 shows the wire pattern of the sixth preferred embodiment of the antenna element in the miniaturized microstrip antenna of the invention. Referring FIG. 8, the first wire pattern (12) is the wire distribution circuit consisting of a plurality of the horizontal wires (14) and the vertical wires (15), on which the vertical wires (15) are zigzag.

The above mentioned is only to describe the preferred embodiments of the invention, which does not intend to limit the invention in any aspect; therefore, any ornament or modification with the spirit of the invention should be still within the scope of the protection claimed by the invention.

What is claimed is:

1. A miniaturized microstrip antenna, which comprises:
an antenna element fabricated by paving a first wire pattern made of a metal circuit on the surface of a first dielectric layer, wherein the operation of said antenna element is used as one of the following: element for receiving signals at a specific frequency band, element for transmitting signals a specific frequency band, and element for simultaneously receiving and transmitting signals at a specific frequency band; and
a feeding element for working together with said antenna element to choose one of the following features: feeding a specific signal to the said antenna element to transmit, capturing a specific signal received by said antenna element, and simultaneously feeding and capturing a specific signal;
wherein said first wire pattern is the layout circuit which consists of a plurality of horizontal wires and vertical wires, and the geometric parameters defined by said first wire pattern corresponds to the specific signal received or transmitted by said antenna element.

2. The miniaturized microstrip antenna as claimed in claim 1, wherein said first dielectric layer is a board made of FR4 and/or Teflon and/or Duriod and/or fiber glass and/or aluminum oxide and/or ceramics and/or other dielectric materials.

3. The miniaturized microstrip antenna as claimed in claim 1, wherein said first wire pattern is the grid distribution circuit consisting of a plurality of rectangle grids.

4. The miniaturized microstrip antenna as claimed in claim 3, wherein the rectangle grids between rows of said first wire pattern are offset with a fixed distance.

5. The miniaturized microstrip antenna as claimed in claim 1, wherein said first wire pattern is the grid distribution circuit consisting of a plurality of round grids.

6. The miniaturized microstrip antenna as claimed in claim 5, wherein the round grids between rows of said first wire pattern are offset with a fixed distance.

7. The miniaturized microstrip antenna as claimed in claim 1, wherein said first wire pattern is the grid distribution circuit consisting of a plurality of hexagon grids.

8. The miniaturized microstrip antenna as claimed in claim 1, wherein said first wire pattern is the wire distribution circuit consisting of a plurality of horizontal wires and vertical wires, on which the type of zigzag can be chosen for said horizontal wires and/or said vertical wires.

9. The miniaturized microstrip antenna as claimed in claim 1, wherein said feeding element further comprises:
a second dielectric layer, wherein a second wire pattern and a third wire pattern are paved on the top surface and the bottom surface of said second dielectric layer, and said wire patterns are metal circuits;
wherein said second wire pattern forms a ground metal layer, of which the length and width are Lg and Wg, respectively; a portion of said second wire pattern is removed as a hollow portion, of which the length and width are Lh and Lw, respectively; said third wire pattern forms a strip-shaped metal layer with the length and width are Lh and Wh, respectively; and on FIG. 3 the area surrounded by the dotted lines is the projection of the microstrip antenna on said first wire pattern.

10. The miniaturized microstrip antenna as claimed in claim 9, wherein said second dielectric layer is a board made of FR4 and/or Teflon and/or Duriod and/or fiberglass and/or aluminum oxide and/or ceramics and/or other dielectric materials.

11. The miniaturized microstrip antenna as claimed in claim 1, wherein the optimized geometrical parameters at the operating frequency can be found by simulation or numerical analysis.
